(19) United States
(12) Patent Application Publication
(10) Pub. No.: US 2014/0067723 A1
(43) Pub. Date: Mar. 6, 2014

(54) OPTIMIZING LANGUAGE TRANSLATION ORDERS AND AUTOMATING FULFILLMENT

(71) Applicants: Boris Katsevman, Newton, MA (US); Martin Roberts, Cambridge, MA (US)

(72) Inventors: Boris Katsevman, Newton, MA (US); Martin Roberts, Cambridge, MA (US)

(21) Appl. No.: 13/800,053

(22) Filed: Mar. 13, 2013

Related U.S. Application Data
(60) Provisional application No. 61/694,886, filed on Aug. 30, 2012.

(51) Int. Cl. G06Q 30/02

(52) U.S. Cl. CPC G06Q 30/0283
USPC 705/400

(57) ABSTRACT

A method includes, in a network of interconnected computers, each of the computers including at least a processor and a memory, receiving in a server linked to the network a set of specifications to meet a requester's language translation needs, the set generated in a client system linked to the network or directly in the server via an appropriate User Interface, in the server, receiving one or more documents from the client system, in the server, analyzing the received set of specifications and the received one or more documents, in the server, generating a tentative optimum translation service solution for the requester according to the analyzed set of specifications, in the server, organizing the most effective translation process suitable to the requester's specifications, and in the server, returning one or more translated documents to the requester in an acceptable format.

### CROSS REFERENCE TO RELATED APPLICATIONS

This application claims the benefit of U.S. Provisional Application No. 61/694,886, filed Aug. 30, 2012. The entire content of this application is incorporated herein by reference.

### BACKGROUND OF THE INVENTION

The present invention generally relates to language translation services, and more particularly to optimizing language translation orders and automating fulfillment.

In sizable global enterprises, vast amounts of documentation originates in local languages, but for the large amount of data of all types that is transferred across country borders and requires translation, there is a need to increase translation speed, convenience, and cost-effectiveness while preserving the necessary degree of translation quality. For much of the data, particularly information for internal use, a requester may be satisfied with a translation that is of lesser quality than a fully reviewed and edited human translation, if the translation can be delivered much faster and at a much lower cost. A machine translation (MT), for example, can be obtained quickly at an extremely low cost, but there may be numerous random flaws in the translation that make some of it seriously incorrect or even incomprehensible. On the other hand, if speed and cost are not high priorities but quality is paramount, only a fully edited human translation will do.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for optimizing language translation orders and automating fulfillment.

In general, in one aspect, the invention features a method including, in a network of interconnected computers, each of the computers comprising at least a processor and a memory, receiving in a server linked to the network a set of specifications to meet a requester's language translation needs, the set generated in a client system linked to the network, in the server, receiving one or more documents from the client system, in the server, analyzing the received set of specifications and the received one or more documents, and in the server, generating a cost estimate for a tentative optimum translation service solution for the requester according to the analyzed set of specifications.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is a block diagram.

FIG. 2 is an exemplary table.

FIG. 3 is an exemplary table.

FIG. 4 is an exemplary table.

FIG. 5 is an exemplary table.

FIG. 6 is an exemplary table.

FIG. 7 is an exemplary table.

FIG. 8 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

The present invention enables a unique optimizing language translation ordering system and a unique computer-aided fulfillment system, offering a high level of convenience, responsiveness, and security. More specifically, recognizing the wide range of possibilities, the present invention is a complete translation service system that automatically determines the optimum product to meet the translation need, as defined by a set of specifications submitted by the requester, and directs the fulfillment with a unique array of tools and processes to achieve a high level of production effectiveness.

It is an axiom that one can achieve the most desirable translation service level for any two of the three key factors in translation—quality, delivery time, and cost—but not for all three at the same time. Thus, a trade-off is inherent in the process. Through automation of translation ordering and production, the present invention analyzes these interdependent three factors—quality, delivery time, and cost—based on a requester's input of priorities, and instantly computes the tentative optimum service solution. The present invention then enables the requester to revise input priority values, repetitively if necessary, until the requester is fully satisfied that the entered data (see Table 40 in FIG. 4) reflects the true priorities that match the need. The resulting final optimum solution, automatically selected from a large number of options, will then be correct in accordance with these priorities.

Upon submission of the order, the present invention proceeds with managing and controlling the complete fulfillment process.

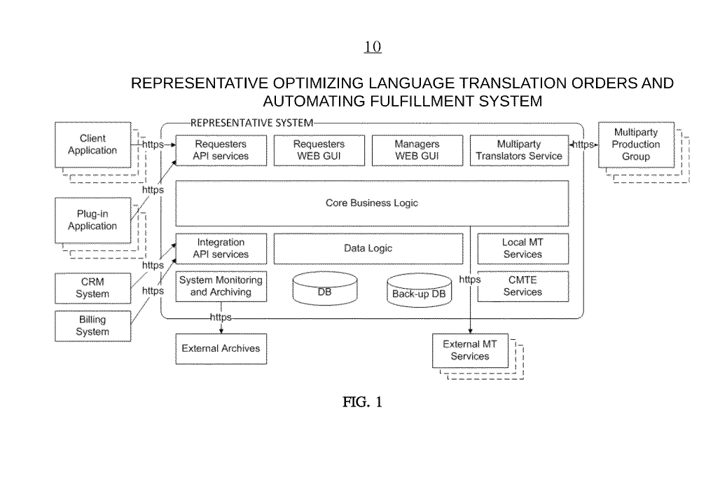

FIG. 1 shows one representative system 10 consisting of one or more servers that may be hosted in the cloud. The main server provides accessibility via a secure (at least 128-bit SSL encrypted) HTTPS network connection. The server exposes an API accessible by client software applications and plug-in (add-on) components for such applications. The server exposes a web GUI for the human requesters and managers. Also the server exposes an API and web GUI for the production group. The system may expose APIs for integration with external CRM and billing systems. FIG. 1 shows Business Logic and Data Logic software components that provide all needed data manipulations from input validation to data persistence. The system also includes system monitoring and data archiving software components. Machine translation (MT) is provided by one or more MT servers that may be external to the system.

In one scenario, a requester using the user device connected to the Internet initiates the translation service through the browser, which displays an interactive graphical user interface (GUI) to the requester. In other scenarios, the present invention is accessed through an application programming interface (API), by a rich client application, or by a plug-in (add-on) application. To ensure security, the requester can only access the translation service using credentials verified by this system. For the additional security, the present invention maintains a logging/event service that records transaction origination.

Translation Order Description

One of the most important decisions regarding translation is determining the degree of translation quality of the target language text. In general, translation quality refers to the faithfulness to the source text, including intended meaning without ambiguity, correctness of terminology and composition, and readability. When a requester only needs to review foreign documents for approximate relevance, there may be no need to have a high quality translation with full layout retention; a more economical machine translation is sufficient. On the other hand, a translation of an official certificate or a drug label destined for a wide consumer audience must be as accurate as possible. Thus, translation quality needs can vary, and selection of the appropriate quality (“good enough” if desired) is the first consideration when placing an order.

The present invention enables six levels of translation quality to accommodate a range of translation purposes.

The least expensive and the fastest level of translation quality is machine translation (MT) performed by a computer software application, usually referred to as a machine translation engine (MTE). The present invention can use translation engines built on different paradigms in their software design and utilizing different software algorithms, the most popular among which are rule-based engines, semantic engines, statistical engines, and hybrid engines. In general, MT engines fall short of good human accuracy and fluency. Yet the overall MT text usually does provide some comprehension if the reader is willing to tolerate various degrees of faults. On the positive side, the output is available very fast and very cheap.

The most widely used algorithm for evaluating MT translation quality is the so-called BLEU (Bilingual Evaluation Understudy) algorithm that is based on comparison with a presumably good human translation of the same text. A BLEU Score is most useful as a reference for comparing translation quality of the output from a particular engine against the output of widely-used commercial engines, such as Google or Bing, for the same source text.

A second level of translation quality is enhanced machine translation that uses a Customized MT Engine (CMTE) designed specifically for translating texts within a particular domain, generally based on documentation supplied by the requester, e.g., technical pharmaceutical documentations. This can be augmented by glossaries and verified Translation Memory (TM) made up of previously performed translations in the language pair and domain of the subject text. The use of specially and selectively profiled language sources for training of these engines enables the engines to translate correctly specific topical terms that will otherwise be “unknown” to the engine. From these sources, the engine learns also the specific style of desired results, e.g., patents have a different style from contract agreements. Such enhancement significantly raises the quality level of the CMTE output within the designated domain.

Despite many decades of intensive effort on improving the MT output quality, it is still far below the level produced by a competent human translator versed in the subject matter. However, manually revising the MT output is a highly cost-effective process for obtaining higher quality compared to human translation (HT) without using MT. This process of human revision is referred to as post-editing (PE).

The present invention employs one or more levels of post-editing, which can be customized for a particular client. Representative of this process the description that follows is based on two levels of post-editing, a lower level referred to as Light Post-Editing, (LPE) and a higher level referred to as Full Post-Editing (FPE). These two levels constitute the third and fourth translation quality levels of the present invention. The quality difference between these two PE levels reflects the difference in time spent on the revising. For the current state-of-the-art of MT, the Light Post-Edit uses approximately one-third of the time Human Translation would require, and the Full Post-Edit uses approximately two-thirds of the Human Translation time, with commensurate savings in cost. Each level is aimed at achieving the best results for maximum comprehension within the budgeted time.

The present invention uses the following unique procedures.

For the Light Post-Edit, the priority order for the working time allotted for the revision is accuracy of subject, object, and verb; accuracy of adjectives, adverbs, conjunctions, and correctness of other basic elements; and syntax. The Full Post-Edit has the same priorities but extends the process to a higher degree because the allotted working time is twice as long. Tests have shown the LPE achieves approximately 90% comprehension and the FPE achieves approximately 97% comprehension compared to HT for the same source text, which testifies to the cost-effectiveness of PE.

The fifth and sixth quality levels of the present invention are complete Human Translation of the source documents, without or with a second translator's editing. The Human Translation (HT) captures a more precise interpretation of nuance and produces a more fluent style than the Full Post-Edit can generally achieve. Human Translation with Editing, performed by qualified professionals, provides the highest possible level of translation quality. It is useful for translations that are submitted to official authorities or published for a large audience.

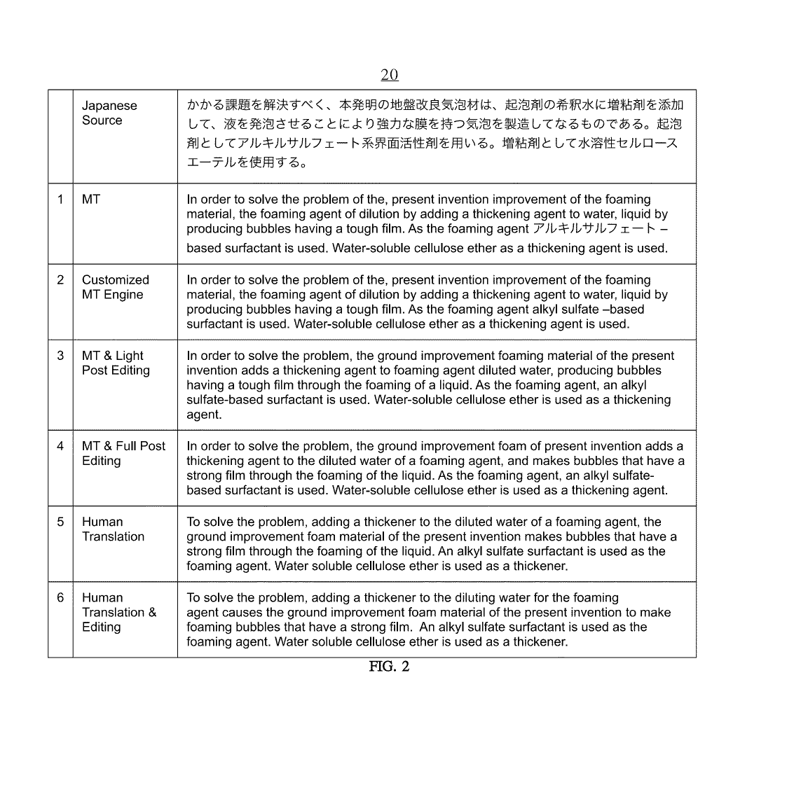

To assist requesters in their decision-making regarding which level of quality to choose, the present invention displays quality samples in a number of languages that represent the differences in quality levels. FIG. 2 illustrates an exemplary table 20 showing these differences.

When a requester submits documents, the present invention generates a cost estimate and delivery by calculating the number of words in all documents submitted, then estimating the number of projected target language words using language-dependent conversion factors, and finally calculating the expected delivery time and cost using stored standard data (see Table 30 in FIG. 3) for each level of translation quality. The present invention compares the results and selects the optimal solution according to the requester's priorities (see Table 40 in FIG. 4). For complex material, the automatic estimates are subject to human verification. Users referred to as Account Managers can change the pricing factors according to exclusive agreements with specific clients.

In precisely meeting the translation need as defined by the requester's expressed priorities, the present invention selects the optimal balance that minimizes cost while maintaining desired quality and delivery time. A very large number of combinations is possible because the system provides five different levels of quality and a delivery time that can vary from one hour to several days for a given shorter text (e.g. 3,000 words), and a few days to several weeks for a given larger text (e.g. >15,000 words) with increments measured in hours, depending on the amount of acceleration desired and acceptable burden of accompanying increased cost.

The present invention arrives at the optimum solution by carrying out a computation based on the requester's input (see Table 40 in FIG. 4) of the following three groups of parameters: 1) preferred level of quality and minimum acceptable level of quality (decided by viewing standard translation samples such as those in Table 1); 2) preferred delivery date and latest acceptable delivery date; and 3) maximum acceptable cost. The system of the present invention then computes the types of resources needed, e.g., human and/or machine, the number of work hours to fit within the specified delivery, and cost, as shown in the examples below. When the order contains special requests, such as graphic work, their cost is added and the result is presented to the requester. The requester is then invited to change one or more answers to these priority questions in order to explore the effect on the resulting optimum solution. When completed, the requester can feel confident he/she has chosen the right balance and the resulting optimum solution produced by the present invention is the best solution for the overall situation.

The unique capability of automatically determining and presenting the precise optimized solution from among a large number of options provides high value to the requester, a value that, depending on circumstances, may far surpass the value of all conventional ordering and managing translation systems available in the marketplace today.

As an example, a requested accelerated delivery schedule may necessitate using multiple concurrent translators and editors, which will increase the cost, perhaps 25% or more (see Table 30 in FIG. 3), due to the higher job management and team coordination expenses. If the proposed cost is still within the requester's budget, the requester may place the order, or decide to investigate further by changing the original input priority specifications and examining the effect on the resulting the optimum solution.

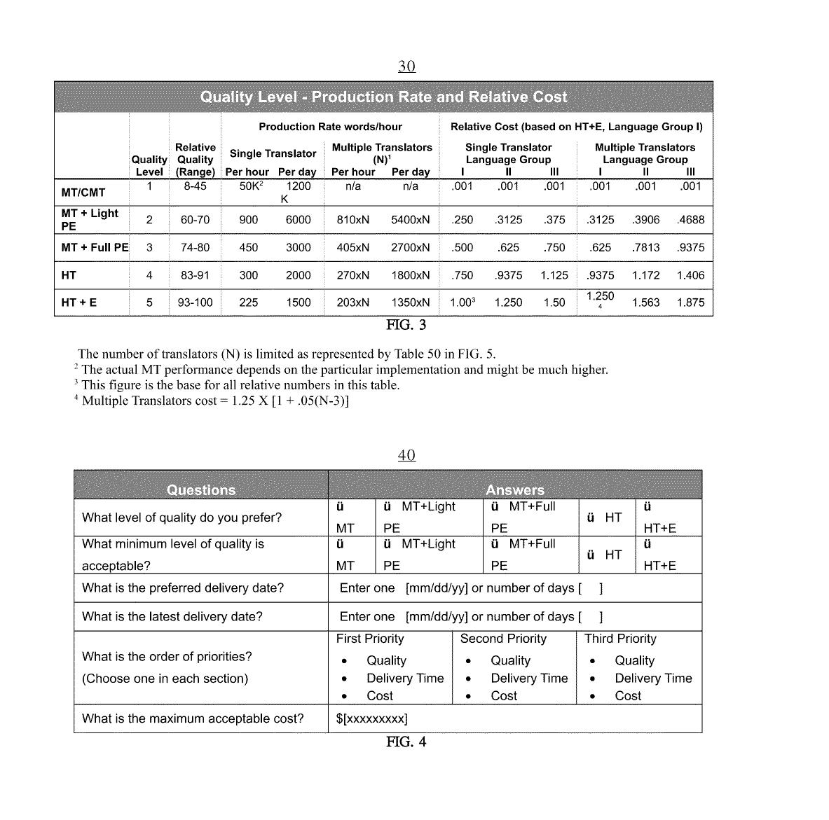

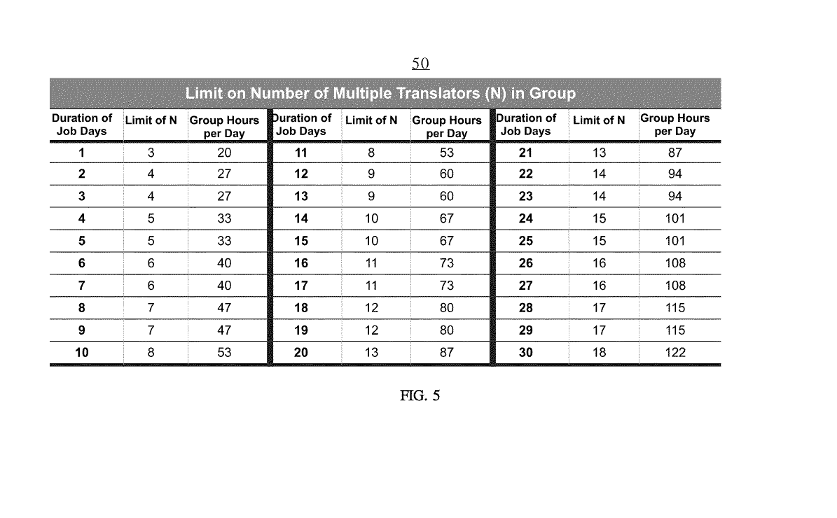

In one specific example, a requester submits a file containing one hundred pages and wants to explore the possibilities for translation into a specified language. The requester may be satisfied with a machine translation (MT) that provides only an approximate rendering of the meaning, but can be delivered within 30 minutes at minimal cost. To improve the quality, raw machine output could receive a light human post-edit (MT+Light PE), producing a comprehensible translation that may still contain syntactical and grammatical errors. This task could be completed by a single human post-editor within 6 days at about one-third the cost of a full human translation (HT, no MT), while a team approach with eight post-editors could complete the same task with the same quality level in just one day at modest higher cost. As an alternative, the raw machine output could receive a full human post-edit (MT+Full PE), producing a translation of near human translation quality. This task could be completed by a single post-editor within 8 days at two-thirds the cost of a full human translation (HT, no MT), while a team approach with five post-editors could complete the same task with a similar quality level in only 2 days at modest higher cost. At the high end, a team of one human translator and one editor (HT+E) would require 16 days at a significantly higher cost to produce a translation of near flawless quality, while an accelerated collaborative effort by nine translators and three editors could complete the same translation at a similar high quality level in just 2 days, but at higher cost. To guide the requester's decision, the present invention uses data similar to the examples presented in Table 30 (in FIG. 3) and Table 50 (in FIG. 5). These tables show data for translations of five different quality levels for the particular language pair involved and the relative cost of each level on a scale from 1 to 1000 for translations involving five different quality levels for a given language pair. For accelerated delivery involving human work, the present invention employs a multiparty system for collaborative participation by two or more translators and others as required. The production acceleration and cost are a linear function of the number of translators (N) as shown in Table 30 (in FIG. 3). There may be practical limits to the rate of adding concurrent translators, and an example of this factor is represented by Table 50 (in FIG. 5).

Provision of Other Capabilities for the Requester

The present invention can automatically detect the language of a source document. Determining the source language is necessary to run the text through the MT software. Also, requesters often want to know the source language for document categorization purposes.

The present invention enables requesters to make additional requests about the desired presentation of the translation outcome, such as preserving look and feel of the source documents. This may involve, for example, specific graphic editing, desktop publishing, preserving some terms in the original language, and so forth.

The present invention enables requesters to make additional requests such as certification without or with notarization of translated materials performed by qualified human personnel.

The present invention can simplify ordering by considering a set of documents as a single Translation Order when these documents are submitted together and share the same need for translation service, e.g. the same language pair, the same content matter, the same translation purpose, and possible other special requests.

Translation Order Lifecycle

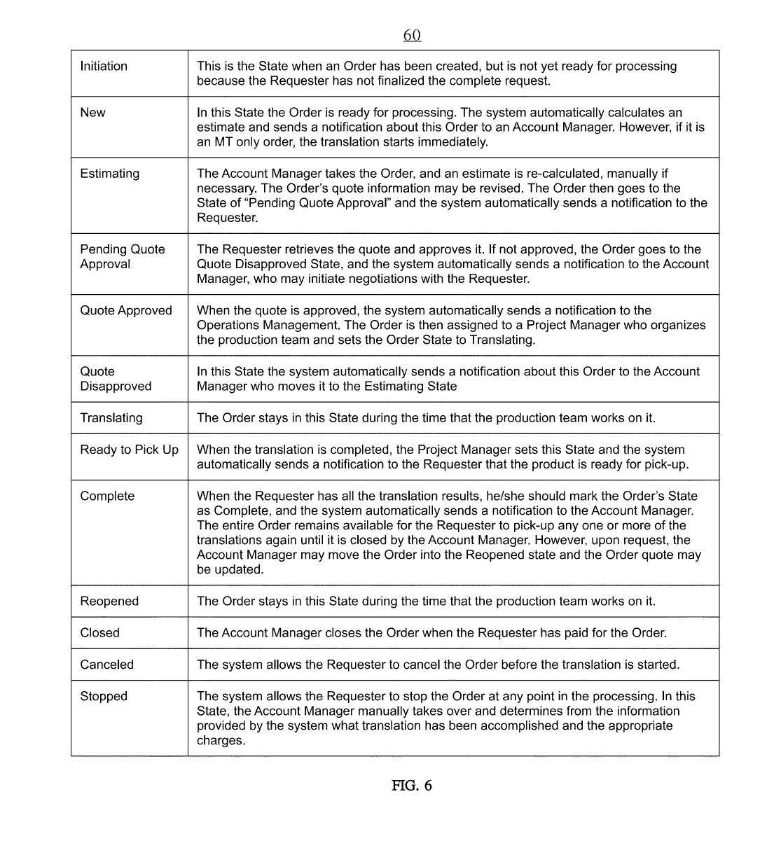

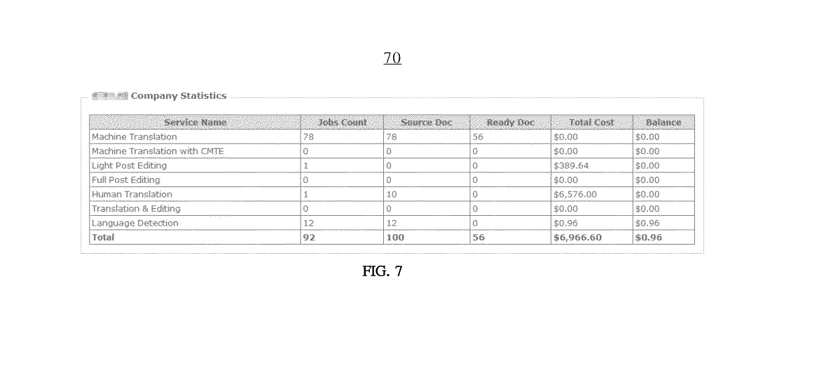

During its lifecycle, a translation order goes between different states with different processing goals. A “state” is a particular condition or status within the translation order lifecycle. In one implementation the present invention supports the following set of states (Table 60 in FIG. 6).

Translation Order Processing

The present invention has many advantages in addition to being beneficial to the requesters. For example, the present invention is an effective management tool for processing translation orders. The present invention notifies account managers about the creation of new translation orders and changes in their states. The present invention enables account managers to create translation orders and change their content on behalf of the requester.

The present invention supplies the service company with identification information about the customers and requesters, for example, such as names, phone numbers, addresses, and so forth, and with analytical information about the characteristics of the translation orders.

In one embodiment, the present invention may be used as a customer relationship management (CRM) system or integrated with an external CRM system via an application programming interface (API). This streamlines managing interactions with customers and requesters, decreasing the amount of manual work and eliminating manual data transfer from the present invention to other systems.

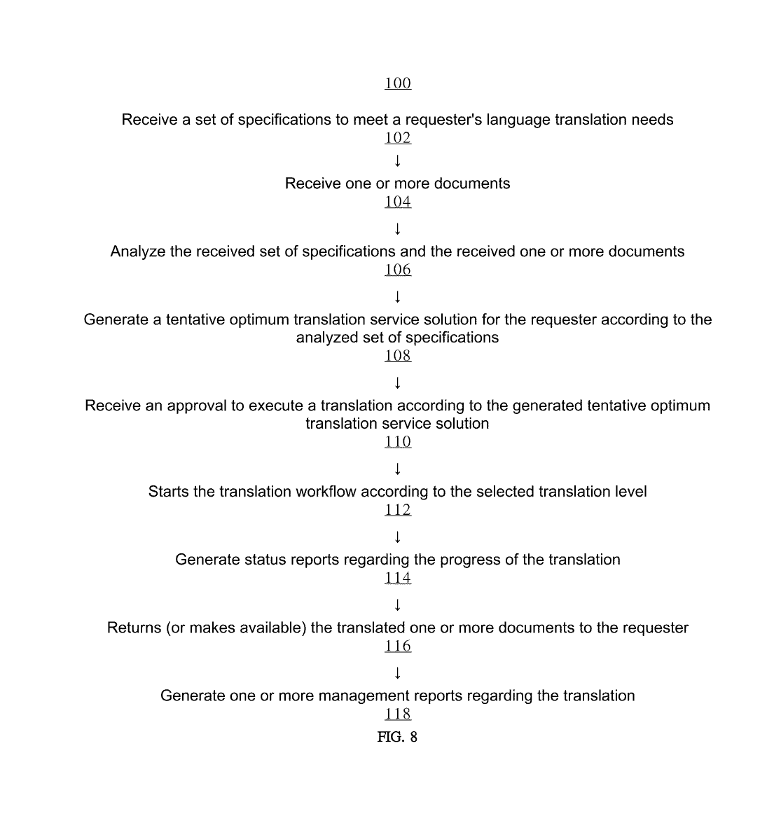

The present invention generates reports needed for billing the customers in accordance with the offer, or periodically for continuing projects. The reports can be a list of jobs completed during the designated period with the details such as the date, service, and price for each job, or it can be a summary as in the example of a report 70 in FIG. 7.

In one embodiment, the present invention can be integrated with an external financial or accounting system via an API to decrease the amount of manual work in the customer's billing process and to eliminate manual data transfer to other systems.

The present invention notifies project managers about relevant changes in the state of translation orders and their readiness for further processing.

For MT, the present invention may use MT engines provided by third parties. Switching between different internal and external MT engines can be made without interrupting services, which adds versatility and efficiency to the system.

The present invention maintains a database of human translators, editors, and other production personnel, including information about their rates, professional qualifications and tested competency, daily output and availability, historical accomplishments, and other details needed for project managers to choose translators, editors, and other production personnel most suitable for the immediate order.

The present invention informs the project managers about the current availability of the selected human translators, editors and other production personnel.

The present invention supplies the providing company with information about the personal load of account managers, project managers, and other resources. The present invention can be used as a special resource planning and management (RPM) system or integrated with an external RPM system via an API.

The present invention enables project managers to assign new orders to the desired human translators, editors, and other production personnel, to define particular steps in the order processing, and to keep track of the order fulfillment progress.

The present invention can be used as a Project Management (PM) system or integrated with an external PM system via an API.

The present invention supports project managers in organizing rapid coordinated multiparty human translation thereby reducing delivery time as needed. Depending on the order, the translation time for a larger document, e.g. one hundred pages, can be less than one-tenth of a traditional delivery time.

Rapid Multiparty Translation

The present invention enables project managers to assign a group of human translators, editors, and other production personnel for concurrent and collaborative processing of an order. For that purpose, the present invention can automatically divide large documents into segments to be assigned to the group members. Concurrent production decreases the overall production time, approximately in proportion to the number of translators in the group.

The group may include translators, editors, proofreaders, subject experts (for the target language accuracy and terminology), DTP/multimedia, and so forth. The present invention also enables simultaneous participation from the beginning by reviewers provided by the requester, which improves efficiency and effectively eliminates the extra time normally needed for acceptance after delivery. All these people may work concurrently rather than in serial format, resulting in a highly accelerated delivery.

The present invention facilitates sharing the same Translation Memory (TM) among the group members, i.e., each group member working online uses the same TM instance. A group member may have a local copy of that TM that enables him/her to continue the work in the event of disconnection; when the connection is restored, this local TM is integrated and reconciled with the group's instance. Each group member may use a personal copy of the project's TM that is reconciled with the rest of the copies upon completion of each translation segment. Thus, each clause translated by each group member becomes immediately available to the rest of the group and supervised by an editorial monitor.

The present invention facilitates coordination of the group work and unification of the style because the translation made by one group member is available to the rest of the group (as described below). Consistency of terminology is preserved by automated rejection of a different word choice from that which exists in the TM, unless overridden by an editor.

The present invention facilitates sharing of the combined knowledge of the group. Similarly to the aforementioned sharing of TM, the present invention makes notes, glossaries, and other referencing materials visible to all group members. The shared greater knowledge of the group as a whole compared to that of a single translator contributes toward overall superior quality.

The present invention registers every action of each translation group member, providing the basis for accurately determining the personal contribution and the payment due each member of the group.

Data Transfer

The present invention accepts incoming documents in different electronic formats, such as, for example, TXT, HTML, DOC, DOCX, XLS, XLSX, PPT, PPTX, PDF, and ZIP files that contain documents of these formats inside. Data received by the present invention is stored in local databases and redundantly stored in the one or more backup servers to provide safe and accurate data integrity.

Data received from the requester is generally a file of a document in a source (first) language. The present invention may translate the document automatically using MT services or facilitate translation that involves human personnel. When the translation is complete, the present invention may deliver the document in the target (second) language to the requester's system or provide access for its downloading.

The present invention may return the translated document in the original format or in a different format if requested. The present invention may automatically convert the result into such formats as PDF, DOCX, or HTML, while preserving the layout of the source document.

Processing Workflow

As shown in FIG. 8, a process 100 for optimizing language translation orders and automating fulfillment includes receiving (102) a set of specifications to meet a requester's language translation needs.

Process 100 receives (104) one or more documents.

Process 100 analyzes (106) the received set of specifications and the received one or more documents.

Process 100 generates (108) a tentative optimum translation service solution for the requester according to the analyzed set of specifications.

Process 100 receives (110) an approval to execute a translation according to the generated tentative optimum translation service solution.

Process 100 starts (112) the translation workflow according to the selected translation level.

Process 100 generates (114) status reports regarding the progress of the translation.

Process 100 returns (116) (or makes available) the translated one or more documents to the requester.

Process 100 generates (118) one or more management reports regarding the translation.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods, and techniques described here.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices, magnetic disks, e.g., internal hard disks or removable disks, magneto optical disks, and CD ROM and DVD-ROM disks. The processor and the memory can be supplemented by, or incorporated in special purpose logic circuitry.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. Accordingly, other implementations are within the scope of the following claims.

What is claimed is:

1. A method comprising:
in a network of interconnected computers, each of the computers comprising at least a processor and a memory, receiving in a server linked to the network a set of specifications to meet a requester's language translation needs, the set generated in a client system linked to the network;
in the server, receiving one or more documents from the client system;
in the server, analyzing the received set of specifications and the received one or more documents; and
in the server, generating a cost estimate for a tentative optimum translation service solution for the requester according to the analyzed set of specifications.

2. The method of claim 1 further comprising:
in the server, receiving an updated set of specifications from the requester;
in the server, analyzing the updated received set of specifications; and
in the server, generating a tentative optimum translation service solution for the requester according to the analyzed updated set of specification.

3. The method of claim 1 where the set is generated directly in the server via a user interface (UI).

4. The method of claim 1 wherein the tentative optimum translation solution comprises a level of translation quality.

5. The method of claim 2 wherein the level of translation quality is machine translation (MT) performed by a machine translation engine (MTE).

6. The method of claim 2 wherein the level of translation quality is enhanced machine translation that uses a customized MTE or CMTE designed for translating texts within a particular domain.

7. The method of claim 6 wherein the MTE or CMTE is augmented by glossaries and translation memory (TM) comprising performed translations in a language pair and domain of the subject text.

8. The method of claim 6 wherein the requester is presented with a list of MTE or CMTE most suitable to the given specifications for the manual selection.

9. The method of claim 2 wherein the level of translation quality is machine translation and light post editing.

10. The method of claim 2 wherein the level of translation quality is machine translation and full post editing.

11. The method of claim 2 wherein the level of translation quality is human translation.

12. The method of claim 2 wherein the level of translation quality is human translation and editing.

13. The method of claim 2 wherein the tentative optimum translation solution further comprises an expected delivery time by calculating a number of words in all documents submitted, estimating a number of projected target language words using language-dependent conversion factors, and calculating the expected delivery time and cost using stored standard data for each level of translation quality.

14. The method of claim 1 wherein generating the tentative optimum translation service solution comprises:
an analysis of preferred level of quality and minimum acceptable level of quality;
a preferred delivery date and latest acceptable delivery date; and
a maximum acceptable cost.

15. The method of claim 1 wherein analyzing the received set of specifications comprises detecting a source text language.

16. The method of claim 1 further comprising, in the server, receiving an approval from the client system to execute a translation according to the generated tentative optimum translation service solution.

17. The method of claim 16 further comprising fulfilling the translation order according to the defined workflow.

18. The method of claim 17 further comprising assigning the translation orders to the most qualified human translation specialists according to the data maintained within the system database of translation specialists.

19. The method of claim 17 further comprising organizing production groups of translators, editors and other specialists for rapid multiparty translation.

20. The method of claim 17 further comprising automatic notification to translation specialists about the assignments and their roles.

21. The method of claim 16 further comprising connecting to the MT server and forwarding the source texts to it for the machine translation by the appropriate MTE or CMTE.

22. The method of claim 16 further comprising returning the translated one or more documents to the requester.

23. The method of claim 16 further comprising generating status reports to the client system regarding the progress of the translation.

24. The method of claim 16 further comprising automatic notification to requesters and managers about changes in the status of translation orders.

25. The method of claim 16 further comprising generating one or more management reports regarding the translation.

26. The method of claim 1 wherein a format of the one or more documents are selected from the group consisting of ASCII, HyperText Markup Language (HTML), DOC, DOCX, XLS, XLSX, PPT, PPTX, Portable Document Format and ZIP format.

27. The method of claim 26 wherein the format of returning translated documents is the same as the source documents received from the requester.
